(19) United States
(12) Patent Application Publication
(10) Pub. No.: US 2004/0222976 A1
(43) Pub. Date: Nov. 11, 2004

(54) Writing pen and recorder with built in position tracking device

(76) Inventors: David Darian Muresan, Seattle, WA (US); David Muresan, Seattle, WA (US)

Correspondence Address: D. DARIAN MURESAN, 18204 30TH AVENUE, SEATTLE, WA, 98155, US

(21) Appl. No.: 10/294,627

(22) Filed: Nov. 15, 2002

(51) Int. Cl. G09G 5/00

(52) U.S. Cl. 345/179

(57) ABSTRACT

A pen for hand-writing recording using an assembly of accelerometers. The accelerometers provide a three dimensional acceleration vector which together with a clock determines the position of the pen at all times. In addition, a sensor on the pen records when the pen is being pressed against a hard surface and it is only then that the pen records the movements of the pen and hence the hand-writing. The writing can be recorded by the pen for later download to a computer system, or the pen can be directly connected to a personal computer, thus providing a a true mouse-type pointing device that does not require any additional tables or touch-pads for two dimensional drawings.

### BACKGROUND OF THE INVENTION

This invention refers to a new hand-writing recording device which can be classified as being in the same family as computer pointing devices and palm-pilot like devices. In particular, this invention introduces an electronic pen that digitally records hand-writing, without the help of any outside positioning sources. The hand-writing information can be stored in the pen, for later retrieval, or transmitted directly to a computer.

Most computer pointing devices, such as the regular mouse are awkward to use for freehand drawing and/or writing. Improvements over standard mouse pointing devices have been patents U.S. Pat. No. 5,371,516 and U.S. Pat. No. 5,434,594 which suggest using a modified mouse device that looks more like a pen, but still use the idea of a ball and X and Y coordinates to locate the pens position. This works well when the pen like device is on a hard surface, but once it's lifted in the air, the X and Y coordinates are no longer transmitted to the computer. These devices are therefore not as easy to use for hand writing or free drawing, where the pen is often lifted off the drawing surface.

To alleviate the above mentioned drawbacks, other patents such as U.S. Pat. No. 6,246,391 provide 3-D computer input devices. In these cases, the location of the pointing device is known in 3-D, but these devices are still awkward to use for writing. For solving the problem of hand writing and free hand drawing on a computer, the best solutions thus far have been patents like U.S. Pat. No. 5,945,981, U.S. Pat. No. 6,380,929 B1, and U.S. Pat. No. 6,351,260 B1 which suggest using touch-pads or light emitting sources, in conjunction with a pen to determine the pen's position in the writing space even after the pen is lifted off the writing surface and moved to a different location on the writing surface. Indeed, these patents do provide a more satisfying solution to hand-writing and free drawing on the computer. Their drawback is the requirement of a touch-pad or other external sources, in addition to the writing device. Our patent eliminates the need of any external devices outside the writing pen itself.

In addition, our digital writing pen can be used as a personal assistant device, similar to the palm-pilot devices. Some of the drawbacks of palm-pilot type devices is that they are somewhat bulky, and any information must be written on the device's screen. Our writing device can be used to record everything a person writes on a piece of paper and then allows the user to reproduce the writing on a computer device.

Our invention is based on an extension of patent U.S. Pat. No. 5,492,010, which provides a position identification device using accelerometers. Our patent contains two new ideas. The first idea is using a location determination device for hand writing recording. The second idea is an extension of the position identification device in patent U.S. Pat. No. 5,492,010. The extension brought fourth in this patent improves the accuracy of the 3-D position identification device.

### BRIEF SUMMARY OF THE INVENTION

This first part of this invention introduces a writing pen which records writing or sends writing information directly to a computer. The pen is made of an outer case (3) containing a tracking device for locating the position of the pen's tip in 3-D and in real time. A writing switch which is opened when the pen is not writing and closed when the pen is writing signals the on board memory when to record the pen's location, ensuring that only when the pen is writing its position is being recorded. The pen also contains a computer interface for sending the writing information from the pen to the host computer in real or non-real time.

The second part of this invention extends the position tracking idea presented in patent U.S. Pat. No. 5,492,010. By using a multitude of accelerometers (more than three) it is shown that the accuracy of the position tracking device can be increased.

### BRIEF DESCRIPTION OF THE DRAWINGS

FIG. 1 presents an overall picture of the digital writing pen and recorder with built in position tracking device. The pen uses the interface connection between (9) and (10), and (11) to talk to the computer (12).

FIG. 2 represents an enlarged view of the recording pen. In this figure notice the accelerometers (1), positioned close to the tip of the pen, which are used in conjunction with the ball (2) to provide accurate information about the pen's position. Also notice that the pen contains a body (3) and an ink reservoir (4) which ends in the rolling ball (2).

FIG. 3 provides a side-view of the pen's writing tip. Notice the location of the accelerometers (1) relative to the pen's body (3), the pen's writing ball (2) and how the center axes (x, y and z) of the accelerometers (1) intersect at the tip of the pen.

FIG. 4 is a top view of the pen's writing tip. The figure depicts the same section as FIG. 3, but viewed from the top. Notice that the accelerometers are attached to the pen's body (3) and not the ink reservoir (4).

FIG. 5 is a side view of the ink reservoir (4) which ends with the pen's rolling or writing ball (2).

FIG. 6-a is a top view of the rolling or writing ball making contact with three rollers (13). The rollers are lined up in a plane which intersect the ball (2) in circle (15).

FIG. 6-b is a detailed view of one roller (13) and the supporting pin (14), which rotates with the roller to transmit the roller's (13) coordinates and the writing ball's (1) position, when the pen is writing.

FIG. 7-a is a representation of the accelerometers (1) positioned perpendicularly in 2-D, and as mentioned in the U.S. Pat. No. 5,492,010. FIG. 7-b shows the accelerometers lined up in a non-perpendicular position as discussed in this patent. The center axis of the two accelerometers are labeled x and y.

FIG. 8 depicts the use of the accelerometers (1) in an over-complete 2-D basis configuration. In this case three accelerometers are used to determine the 2-D acceleration vector (FIG. 8-a). As explained in the text and in FIG. 8-b, using an over-complete basis configuration provides better resolution of the 2-D acceleration vector.

FIG. 9 is a block diagram of the digital writing pen and recorder with built in position tracking device.

FIG. 10 is a block diagram of the generalized position tracking device using an over-complete set of accelerometers.

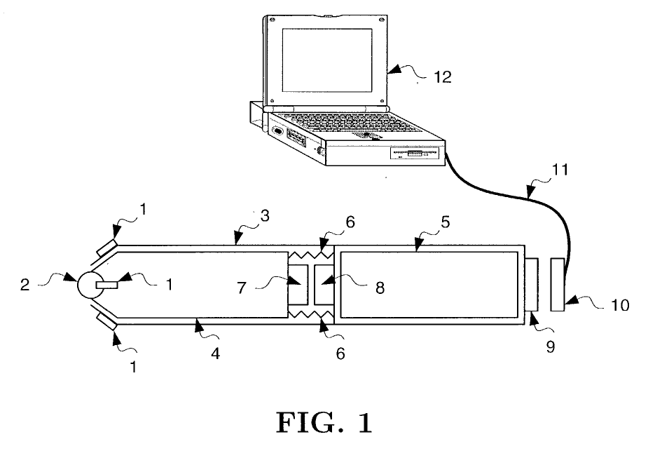

### DETAILED DESCRIPTION OF THE INVENTION

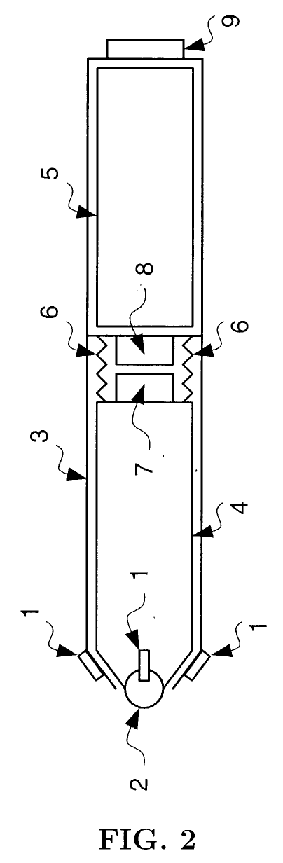

This invention introduces a new writing pen that records free hand writing, even when the writing pen is lifted off the writing surface and positioned in a new location. In order to truly record hand writing, it is important to know the location of the pen's writing tip even when the pen is off the writing table. For example when drawing the plus symbol, most people draw a horizontal line first, then lift the pen and draw a vertical line second. If the position of the pen is tracked only when the pen is on the paper and not when the pen is off the paper, the writing device would be able to tell that the pen traced a vertical and a horizontal line, but would not be able to tell their relative locations and therefore would not be able to correctly record the drawing. To accurately record free hand writing, the location of the pen's tip must be tracked in 3-D. With this understanding, the recording pen and process are described next. The writing and recording pen, which is depicted in FIG. 2, consists of the following.

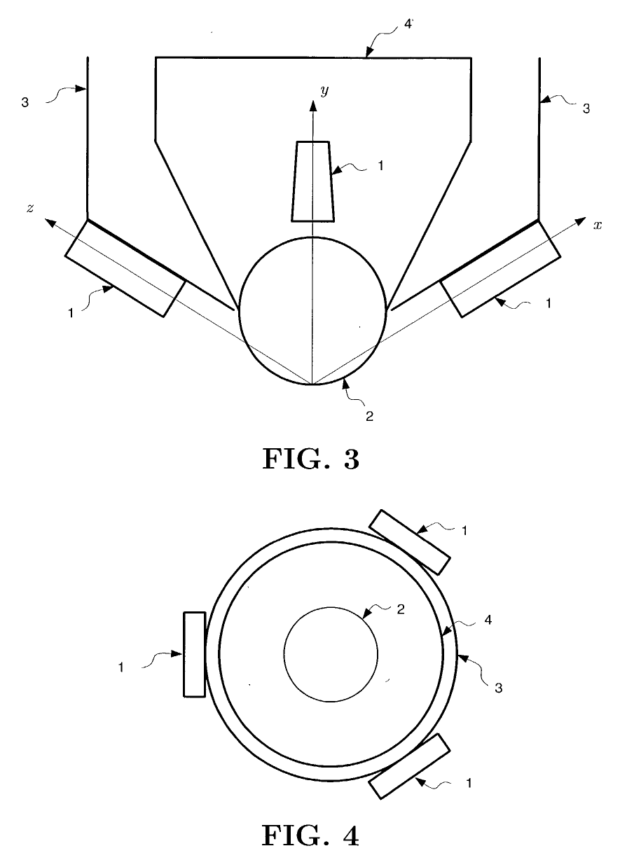

1. First, the pen is made of on outer case (3). When writing, the user holds onto this outer case (3) to write. Close to the tip of the outer case (3) is the positioning device which gives the pen's tip position at all times. In FIG. 2, the position is determined using three accelerometers (1) arranged in 3-D such that taking the center axis of each accelerometer, the three axis intersect at the tip of the pen. (The center axis is a vector in the direction in which the accelerometer measures acceleration. In FIG. 3, these are axis x, y and z.) In addition, the collection of all center axis form a linear independent set, ideally an orthogonal (perpendicular) set.

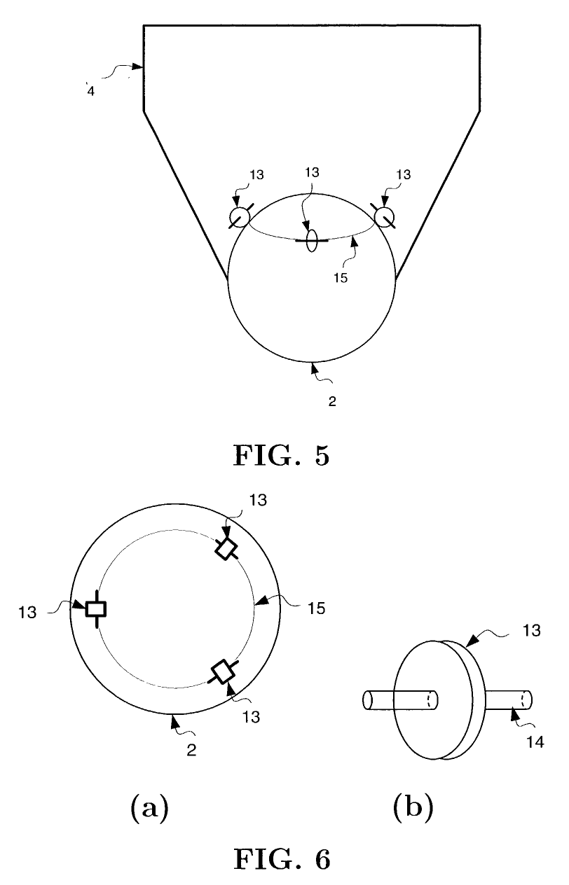

2. Second, the writing pen contains an ink reservoir (4) as in FIG. 5. When the pen is used for writing, the ink reservoir (4) is filled with ink. When the pen is used as a computer pointing device, the ink reservoir may be empty. The ink reservoir ends in a rolling ball, sometimes also called a writing ball (2). For improved precision of the location of the pen, when the pen is writing, the rolling ball is in contact with three rollers (13) which keep track of the position of the rolling ball.

3. At the back end of the ink reservoir (4) is a conductive patch of metal (7) which together with a second conductive patch (8) forms a switch, called the writing switch. When the pen is not used for writing, springs (6) push apart the two conductive patches (7) and (8) and the writing switch is said to be opened. When the pen is writing, the writing pressure brings the two conductive patches (7) and (8) into contact and the writing switch is said to be closed. The role of the writing switch is to tell the status of the pen. When the writing switch is opened the pen is not writing and when the writing switch is closed the pen is writing.

4. The pen also encloses a small digital logic section (5). This section contains a clock, memory for saving the pen's writing position, a computer interface (9) and other computer logic for calculating the position of the pen's tip using the information from the positioning device.

With the construction of the device as mentioned above, the hand-writing recording device works as depicted in FIG. 10 and as described bellow.

1. When the writing device is first turned on, the pen is tapped against the table once. This records the first STOP 3-D (25) position. After the pen has been initialized the writing contact (7) and (8) and the rollers (13) are continuously monitored (20). As long as the writing contact is left open and the rollers (13) are not moving, the pen does nothing.

2. Once the writing contact is closed, the location of where the contact closed is recorded and labeled as the START 3-D location (21). Taking the difference with respect to the previous STOP, determines the new writing START position (22). After this, all writing is recorded (23) until the pen is lifted off the paper and the rollers (13) stop, as in (24).

3. The pen records the latest STOP position (25) and the cycle begins all over again.

Notice that rollers (13) are a redundancy of the positioning device. Potentially, the rollers (13) could add in extra precision in determining the writing location. But if the rollers (13) are removed, the information from the positioning devices (1) is still enough to record the free hand writing. In this case, the word rollers can be safely removed from the flow chart diagram of FIG. 10. In addition, notice that the ink reservoir can be any regular pen. Without the rollers (13), the ink reservoir can be anything that leaves markings on the paper. Without the rollers (13), the ink reservoir is equivalent to the refill in a regular pen.

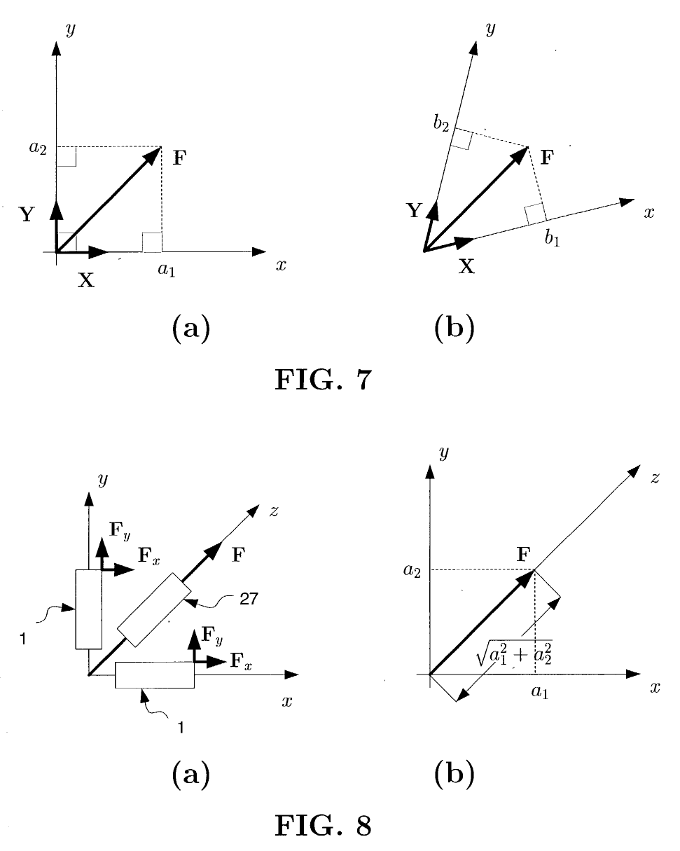

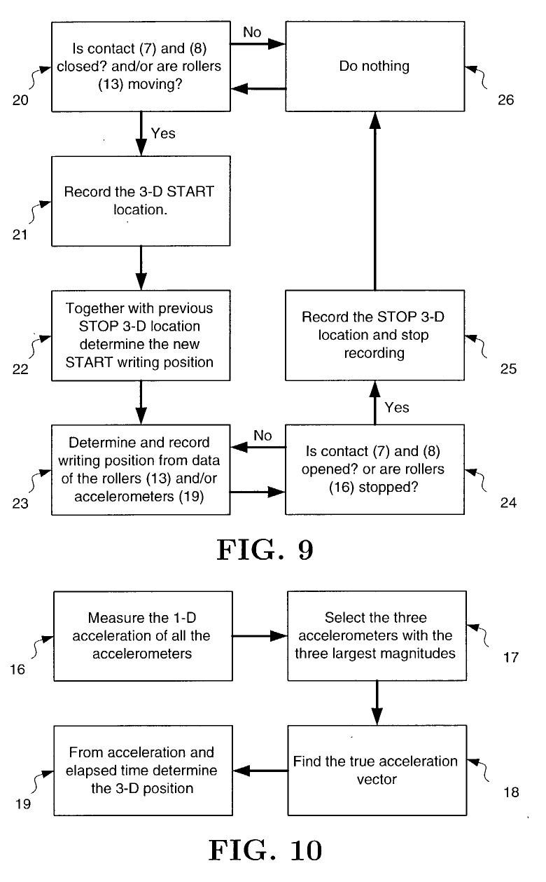

The assumption thus far has been based on the fact that the pen's writing tip can be traced in 3-D. In patent U.S. Pat. No. 5,492,010 Bushman described a 3-D tracking device using three accelerometers with their axis perpendicular to each other as in FIG. 7-a. This, however is not the only way to resolve the 3-D position, nor is it the best way. Next this invention discusses extending Bushman's idea to the case when the axis of the three accelerometers are not orthogonal as in FIG. 7-b. (Non-orthogonality might be an issue in the case of the writing pen since a sharp pen tip might not allow for setting the accelerometers mutually orthogonal.) Further, it discusses improvements to Bushman's idea by using more than three accelerometers to track the 3-D position. For the sake of simplicity, the problem is analyzed in 2-D, as shown in FIG. 7. Assume that two accelerometers are perpendicular to each other as in FIG. 7-a and that the origin is being subjected to an acceleration F at some angle. The reading on the accelerometer in the x direction is a₁, (the magnitude of the orthogonal projection of the acceleration F onto the x axis) and the reading on the accelerometer in the y direction is a₂ (the magnitude of the orthogonal projection of the acceleration F onto the y axis). Similarly, if the accelerometers are not orthogonal (FIG. 7-b) but the origin is subjected to the same acceleration the two accelerometers will have a reading of b₁ (the orthogonal projection of F onto x) and b₂ (the orthogonal projection of F onto y). Let X and Y be two length one vectors in the direction of the axes x and y respectively. If axes x and y are orthogonal (FIG. 7-a), the acceleration vector F is

F=a₁X+a₂Y (28)

If axis x and y are not orthogonal, but are still linearly independent (FIG. 7-b) then it is well known [1] that vector F is

F=c₁X+c₂Y (29)

where constants c₁ and c₂ are obtained using

$$( \begin{matrix}{c}_{1} \\ {c}_{2}\end{matrix} ) = {( \begin{matrix}1 & ( X , Y ) \\ ( X , Y ) & 1\end{matrix} )}^{- 1} ( \begin{matrix}{b}_{1} \\ {b}_{2}\end{matrix} ) \qquad ( 30 )$$

where (X, Y) is the dot product between X and Y. Notice that if X is orthogonal to Y the dot product is zero and the results of (29) simplify to (28).

In 2-D, using only two orthogonal accelerometers can cause slight errors in the readings of the accelerometers due to the non-axial forces on the accelerometers. In FIG. 8-a the non-axial force on the horizontal and vertical accelerometers is F_{y} and Fₓ, respectively. Considering that most accelerometers are based on moving mechanical components, some accelerometer designs may not favor as well in measuring the axial acceleration when there is also a lateral acceleration, especially when the lateral acceleration is much higher than the axial acceleration. An improvement in measuring the true 3-D acceleration is to use more than three accelerometers. In 2-D, this means using more than 2 accelerometers as in FIG. 8-a, with the third accelerometer being the diagonal accelerometer (27). If the third accelerometer (27) has the axial direction in the direction of the acceleration F then this accelerometer (27) makes the best and most accurate reading of F, since there's no non-axial force on the accelerometer. Here is the improved 3-D position tracking device as described in FIG. 10.

1. Using more than three accelerometers (the more, the better) position them such that their center axes intersect in one point. This point's position in space is what will be tracked by the accelerometers.

2. Read the magnitude acceleration of all the accelerometers and select the three accelerometers that have the three largest magnitudes (17). (The important part is the magnitude not the sign, i.e. acceleration or de-acceleration.) If the acceleration is non-zero, the three accelerometers selected will not be orthogonal. Use their acceleration readings, together with the 3-D version of equation (29) to calculate the 3-D acceleration vector (18).

3. Position is the double integral of acceleration with respect to time. Using a clock in conjunction with the 3-D acceleration vector, position can be determined, by integration (in discrete time by summation) up to a constant c (19). The constant c is determined from some initial position, considered to be the origin.

With the improved position tracking design, we are now ready to present our claim.

We claim:

1. A writing pen which records writing or sends writing information directly to a computer and comprising of
an outer case (3) containing a tracking device for locating the position of the pen's tip in 3-D and in real time;
a writing switch which is opened when the pen is not writing and closed when the pen is writing;
a clock which is used in updating the pen's tip location in 3-D, based on the information from the said tracking device;
memory for recording the pen's tip location when the said writing switch is closed (23);
computer logic for transforming the said recorded tip position into writing;
computer interface for sending the writing information from the said pen to the host computer in real or non-real time;
an ink reservoir that allows for making marks on the paper;
the ink reservoir may have at the writing end a rolling ball used for writing or for tracing the pen's location on the writing surface;
optionally, the said rolling ball having contact with three rollers that continuously update the ball's position when the ball is rotating; and
the said rollers updating the pen's tip position when the said writing switch in the said pen is closed.

2. A point of interest tracking position device in three dimensions and comprising of
four or more accelerometers positioned such that their axes intersect in the said point of interest;
the said axes span the entire three dimensional subspace;
an algorithm for reading the magnitudes of accelerations of all the said accelerometers and selecting the three accelerometers with the three largest magnitudes;
using the information from the three said selected non-perpendicular accelerometers to determine the true three dimensional acceleration vector (18);
using the said true three dimensional acceleration vector together with a clock to determine the location of the said point of interest in three dimensions.

3. A writing pen as claimed in claim 1 and using a tracking device, as claimed in claim 2, for locating the position of the pen's tip in 3-D and in real time.
